(19) United States
(12) Patent Application Publication
(10) Pub. No.: US 2006/0290597 A1
(43) Pub. Date: Dec. 28, 2006

(54) Plasma display apparatus

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/471,530

(22) Filed: Jun. 21, 2006

(30) Foreign Application Priority Data
Jun. 24, 2005 (KR) 10-2005-0055329

(51) Int. Cl. G09G 3/28

(52) U.S. Cl. 345/60

(57) ABSTRACT

A plasma display apparatus includes a plasma display panel comprising a first electrode and a second electrode, a first path forming unit forming a first path for supplying an energy to the first electrode and for recoverying the energy from the first electrode, a second path forming unit forming a second path for supplying the energy to the second electrode and for recoverying the enecgy from the second electrode and a capacitor storing the supplied or recovered energy.

This Nonprovisional application claims priority under 35 U.S.C. § 119(a) on Patent Application No. 10-2005-0055329 filed in Korea on Jun. 24, 2005 the entire contents of which are hereby incorporated by reference.

### BACKGROUND OF THE INVENTION

1. Field of the Invention

This document relates to a plasma display apparatus.

2. Description of the Background Art

A plasma display apparatus comprises a plasma display panel in which a plurality of electrodes are formed and driver for driving the plurality of electrodes of the plasma display panel.

The plasma display apparatus displays an image thorugh the plasma display panel. A main discharge gas and an inert gas are filled in each cell of the plasma display panel. The main discharge gas comprises Neon(Ne), Helium(He) or a mixture gas of Neon and Helium(Ne+He). The inert gas comprises Xenon. When a high frequency voltage is supplied to the plurality of electrodes of the plasma display panel, the inert gas generates vacuum ultraviolet rays, and a phosphor formed between barrier ribs emits light.

The driver of the plasma display apparatus supplies a driving signal to the plurality of electrodes of the plasma display panel. In response to the supply of the driving signal, a reset discharge, an address discharge, and a sustain discharge generate. When the discharges generate in a discharge cell of the plasma display panel, the inert gas generates vacuum ultraviolet rays, and a phosphor formed between barrier ribs emits light.

The driver supplies a sustain signal to generate the sustain discharge, and comprises an energy recovery circuit to supply the sustain signal.

### SUMMARY OF THE INVENTION

A plasma display apparatus in accordance with the embodiment of the present invention comprises a plasma display panel comprising a first electrode and a second electrode, a first path forming unit forming a first path for supplying an energy to the first electrode and for recoverying the energy from the first electrode, a second path forming unit forming a second path for supplying the energy to the second electrode and for recoverying the enecgy from the second electrode and a capacitor storing the supplied or recovered energy.

A plasma display apparatus in accordance with the embodiment of the present invention comprises a plasma display panel comprising a first electrode and a second electrode, an energy supply/recovery unit supplying an energy to the first electorde or the second electrode and recovering the energy from the first electrode or the second electrode, a first voltage supply unit remaining a voltage of the first electrode at a first voltage or a first reference voltage and a second voltage supply unit remaining a voltage of the second electrode at a second voltage or a second reference voltage.

A driving method of a plasma display apparatus in accordance with the embodiment of the present invention comprises supplying an energy from the capacitor to the first electrode through a first path, recoverying the energy from the first electrode to the capacitor through the first path, supplying the energy from the capacitor to the second electrode through a second path and recovering the energy from the second electrode to the capacitor through the second path.

### BRIEF DESCRIPTION OF THE DRAWINGS

The embodiment of the invention will be described in detail with reference to the following drawings in which like numerals refer to like elements.

FIG. 1 illustrates a plasma display apparatus in accordance with an embodiment of the present invention;

FIG. 2 illustrates a waveform diagram of a driving signal of the plasma display apparatus in accordance with the embodiment of the present invention;

FIG. 3 illustrates an energy recovery circuit of the plasma display apparatus in accordance with the embodiment of the present invention;

FIG. 4 illustrates a switching timing diagram of the energy recovery circuit of the plasma display apparatus in accordance with the embodiment of the present invention; and

FIG. 5 to FIG. 11 illustrate current pathes of the energy recovery circuit of the plasma display apparatus in accordance with the embodiment of the present invention.

### DETAILED DESCRIPTION OF PREFERRED EMBODIMENTS

Embodiments of the present invention will be described in a more detailed manner with reference to the drawings.

A plasma display apparatus in accordance with the embodiment of the present invention comprises a plasma display panel comprising a first electrode and a second electrode, a first path forming unit forming a first path for supplying an energy to the first electrode and for recoverying the energy from the first electrode, a second path forming unit forming a second path for supplying the energy to the second electrode and for recoverying the enecgy from the second electrode and a capacitor storing the supplied or recovered energy.

The plasma display apparatus in accordance with the embodiment of the present invention may further comprise a first voltage supply unit for supplying a first voltage or a first reference voltage, and a second voltage supply unit for supplying a second voltage or a second reference voltage.

A magnitude of the first voltage may be substantially equal to the magnitude of the second voltage.

The first reference voltage and the second reference voltage may be substantially equal to a ground level voltage.

The first path forming unit may comprise a first switch and a first inductor connected in serial each other, and the second path forming unit may comprise a second switch and a second inductor connected in serial each other.

The first switch may be connected between the capacitor and the first inductor, and the second switch may be connected between the capacitor and the second inductor.

A plasma display apparatus in accordance with the embodiment of the present invention comprises a plasma display panel comprising a first electrode and a second electrode, an energy supply/recovery unit supplying an energy to the first electorde or the second electrode and recovering the energy from the first electrode or the second electrode, a first voltage supply unit remaining a voltage of the first electrode at a first voltage or a first reference voltage and a second voltage supply unit remaining a voltage of the second electrode at a second voltage or a second reference voltage.

The energy recovery/supply unit may comprise an energy storage unit for storing the energy, a first switch and a first inductor connected between the energy storage unit and the first voltage supply unit to supply or recovery the energy to or from the first electrode, and a second switch and a second inductor connected between the energy storage unit and the second voltage supply unit to supply or recovery the energy to or from the second electrode.

The first switch may be connected between the capacitor and the first inductor, and the second switch may be connected between the capacitor and the second inductor.

A magnitude of the first voltage may be substantially equal to the magnitude of the second voltage.

The reference voltage and the second reference voltage may be substantially equal to a ground level voltage.

A driving method of a plasma display apparatus in accordance with the embodiment of the present invention comprises supplying an energy from the capacitor to the first electrode through a first path, recoverying the energy from the first electrode to the capacitor through the first path, supplying the energy from the capacitor to the second electrode through a second path and recovering the energy from the second electrode to the capacitor through the second path.

A voltage of the first electrode may remain at a first voltage after the supply of the energy to the first electrode, and a voltage of the second electrode may remain at a second voltage after the supply of the energy to the second electrode.

A magnitude of the first voltage may be substantially equal to the magnitude of the second voltage.

A voltage of the first electrode may remain at a first reference voltage after the recovery of the energy from the first electrode, and a voltage of the second electrode may remain at a second reference voltage after the recovery of the energy from the second electrode.

The reference voltage and the second reference voltage may be substantially equal to a ground level voltage.

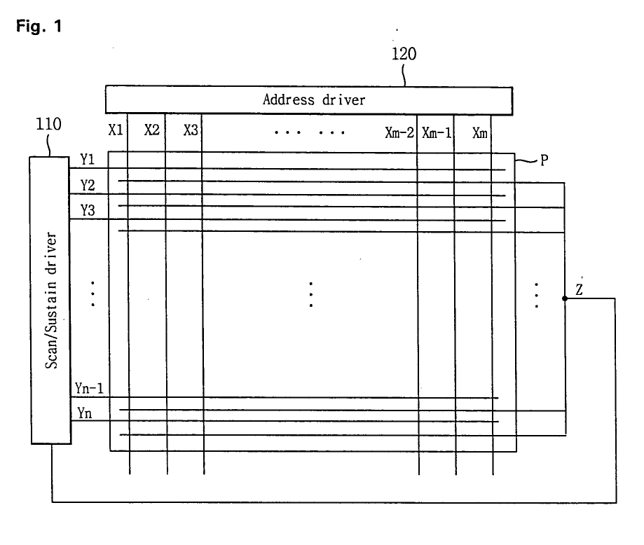

FIG. 1 illustrates a plasma display apparatus in accordance with an embodiment of the present invention.

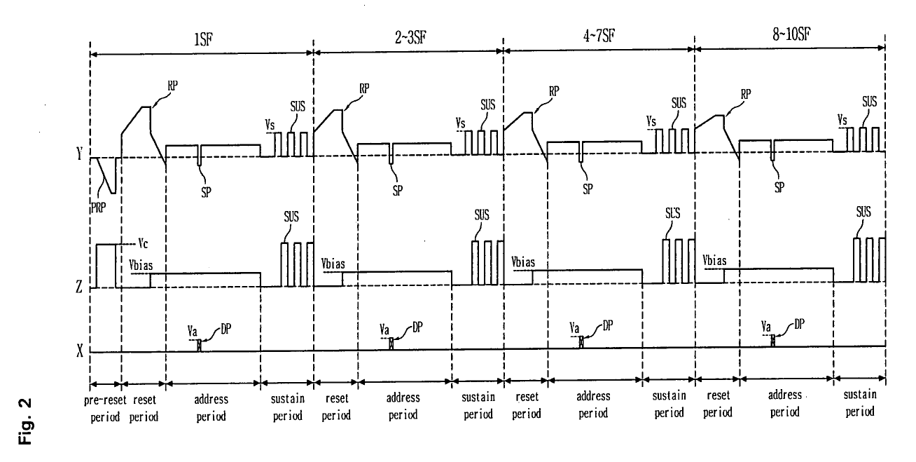

FIG. 2 illustrates a waveform diagram of a driving signal of the plasma display apparatus in accordance with the embodiment of the present invention.

As illustrated in FIG. 1, the plasma display apparatus comprises a plasma display panel P, a scan/sustain driver 110, and an address driver 120.

The plasma diplay panel P comprises a plurality of scan electrodes Y₁ to Yₙ, a sustain electrode Z, and a plurality of address electrodes X₁ to Xₘ.

The scan/sustain driver 110 supplies a pre-reset signal PRP of FIG. 2 falling gradually to form enough wall charges to the scan electrode (Y) in a pre-reset period of a first subfield 1SF. The scan/sustain driver 110 supplies a reset signal RP for an initiation of an wall charge state of a discharge cell, a scan signal SP for a selection of the discharge cell, and a sustain signal SUS for a sustain discharge of the selected discharge cell, to the scan electrode Y. The scan/sustain driver 110 may supply the reset signals RP having different magnitudes to the scan electrode Y in subfields. For example, because wall charges are formed enoughly in the first subfield 1SF, the maximum magnitude of the reset signal RP supplied in subfields 2SF to 10SF following the first subfield 1SF, may be less than the maximum magnitude of the reset signal RP supplied in the first subfield 1SF.

The scan/sustain driver 110 supplies a positive voltage Vc corresponding to the pre-reset signal PRP, a bias voltage Vbias, and the sustain signal SUS for the sustain discharge of the selected discharge cell, to the sustain electrode Z.

The address driver 120 supplies a data signal DP, for a selection of the discharge cell, corresponding to the scan signal SP, to the plurality of address electrodes X₁ to Xₘ.

The scan/sustain driver 110 comprises an energy recovery circuit to supply the sustain signal to the plurality of scan electrodes Y1 to Yn and the sustain electrode Z.

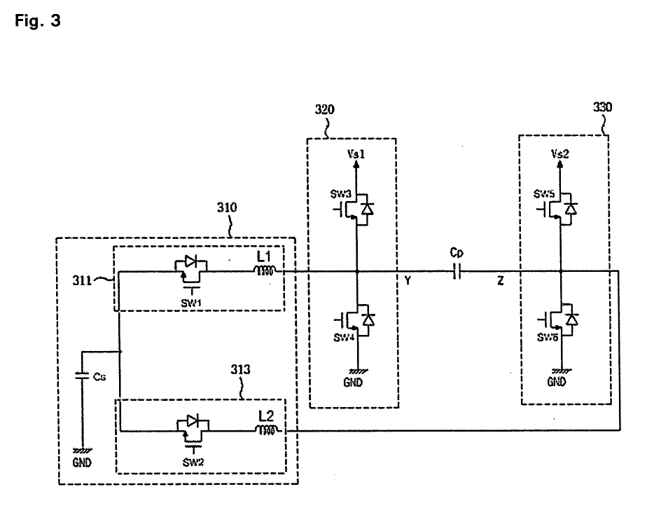

FIG. 3 illustrates the energy recovery circuit of the plasma display apparatus in accordance with the embodiment of the present invention. As illustrated in FIG. 3, the energy recovery circuit of the plasma display apparatus in accordance with the embodiment of the present invention comprises an energy recovery/supply unit 310, a first voltage supply unit 320, and a second voltage supply unit 330.

The energy recovery/supply unit 310 supplies an energy to a scan electrode Y or a sustain electrode Z of a plasma display panel Cp, and recovers the energy from the scan electrode Y or the sustain electrode Z. The energy recovery/supply unit 310 comprises a capacitor Cs, a first path forming unit 311, and a second path forming unit 313. The capacitor Cs stores the energy supplied to or recovered from the scan electrode Y or the sustain electrode Z. The first path forming unit 311 forms a first path for supplying the energy to the scan electrode Y and recovering the energy from the scan electrode Y. The first path forming unit 311 comprises a first switch SW1 and a first inductor L1 connected each other. One terminal of the first switch SW1 is connected to one terminal of the capacitor Cs, and the other terminal of the first switch SW1 is connected to one terminal of the first inductor L1. When the energy is recovered or supplied through the first path, the first inductor L1 forms LC resonance. The second path forming unit 313 forms a second path for supplying the energy to the sustain electrode Z and recovering the energy from the sustain electrode Z. The second path forming unit 311 comprises a second switch SW2 and a second inductor L2 connected each other. One terminal of the second switch SW2 is connected to one terminal of the capacitor Cs, and the other terminal of the second switch SW2 is connected to one terminal of the second inductor L2. When the energy is recovered or supplied through the second path, the second inductor L2 forms an LC resonance. The other terminal of the second inductor L2 is connected to the sustain electrode Z.

The first voltage supply unit 320 remains a voltage of the scan electrode Y at a first voltage Vs1 or a first reference voltage. The first voltage supply unit 320 supplies the first voltage Vs1 to the scan electrode Y after the energy is supplied from the capacitor Cs to the scan electrode Y through the first path, and supplies the first reference voltage to the scan electrode Y after the energy is recovered from the scan electrode Y to the capacitor Cs through the first path. The first voltage Vs1 may be for a generation of the sustain discharge in the discharge cell. The first reference voltage is substantially equal to a ground level voltage. The first voltage supply unit 320 comprises a third switch SW3 and a fourth switch SW4 for the supply of the first voltage Vs1 and the first reference voltage.

The second voltage supply unit 330 remains the voltage of the sustain electrode Z at the second voltage Vs2 or the second reference voltage. The second voltage supply unit 330 supplies the second voltage Vs2 to the sustain electrode Z after the energy is supplied from the capacitor Cs to the sustain electrode Z through the second path, and supplies the second reference voltage to the sustain electrode Z after the energy is recovered from the sustain electrode Z to the capacitor Cs through the second path. The second voltage Vs2 may be for a generation of the sustain discharge. The second reference voltage may be substantically a ground level voltage. The second voltage supply unit 330 comprises a fifth switch SW5 and a sixth switch SW6 for the supply of the second voltage Vs2 and the second reference voltage.

A magnitude of the first voltage Vs1 may be substantially equal to the magnitude of the second voltage Vs2. The capacitor Cs stores the energy corresponding to the half of the first voltage Vs1 or the half of the second voltage Vs2.

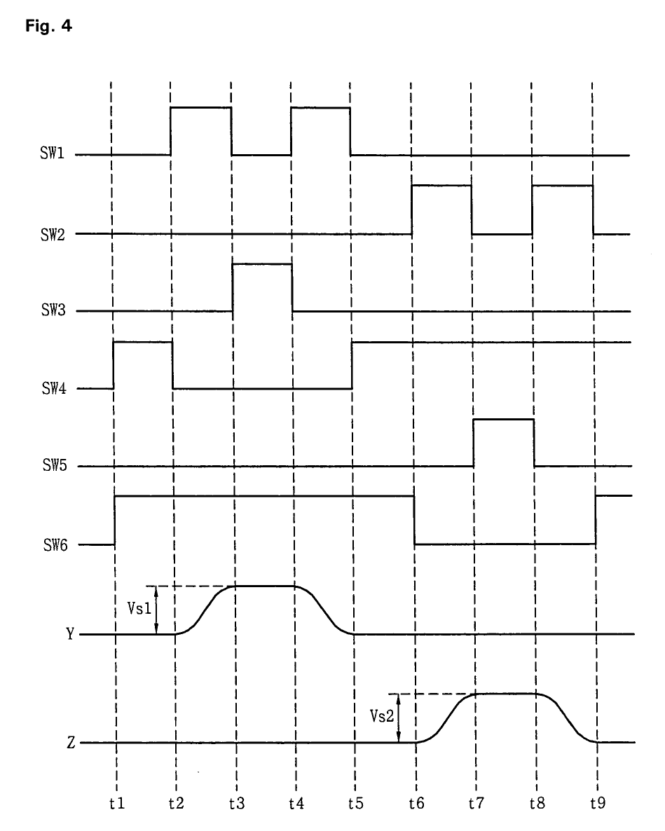

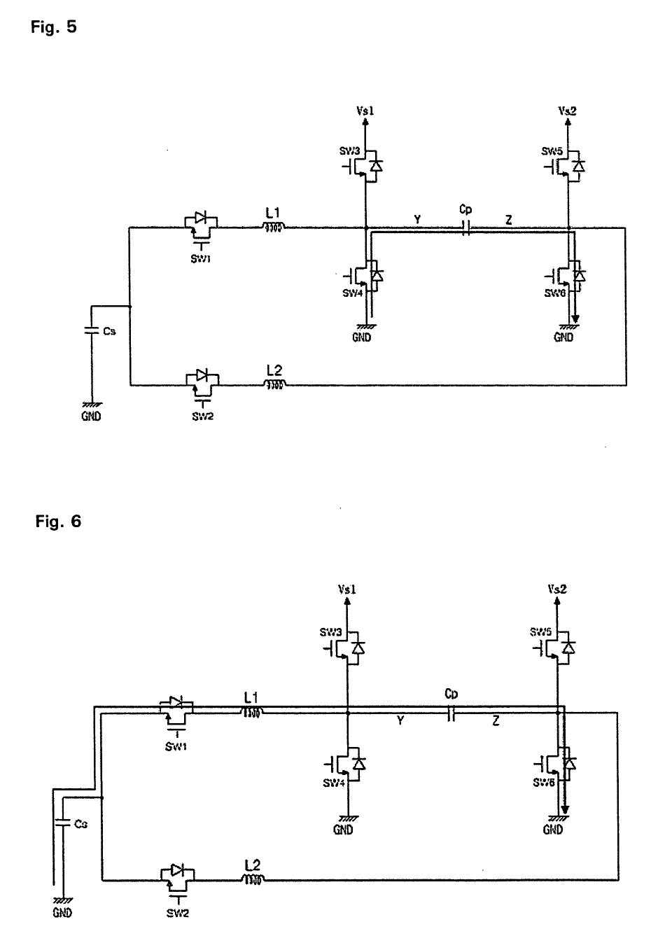

FIG. 4 illustrates a switching timing diagram of the energy recovery circuit of the plasma display apparatus in accordance with the embodiment of the present invention. FIG. 5 to FIG. 11 illustrate current pathes of the energy recovery circuit of the plasma display apparatus in accordance with the embodiment of the present invention.

At the time point t1, the foruth switch SW4 and the sixth switch SW6 are turned on in response to a fourth switching control signal of a high level and a sixth switching control signal of a high level supplied by a timing controller (not illustrated). As illustrated in FIG. 5, a current path comprising the fourth switch SW4, the scan electrode Y, the sustain electrode Z, and the sixth switch SW6, is formed. The first reference voltage and the second reference voltage are supplied to the scan electrode Y and the sustain electrode Z.

At the timoe point t1, the foruth switch SW4 is turned off in response to a fourth switching control signal of a low level supplied by a timing controller. The sixth switch SW6 remains in a turn-on state and the first switch SW1 is turned on in response to the sixth switching control signal of the high level and a first switching control signal of the high level which are supplied by the timing controller. As illustrated in FIG. 6, a current path comprising the capacitor Cs, the first switch SW1, the inductor L1, the scan electrode Y, the sustain electrode Z, and the sixth switch SW6, is formed. The energy stored in the capacitor Cs is supplied to the scan electrode Y. The first inductor L1 and an equivalent capacitor of the plasma display panel Cp form a serial resonance circuit.

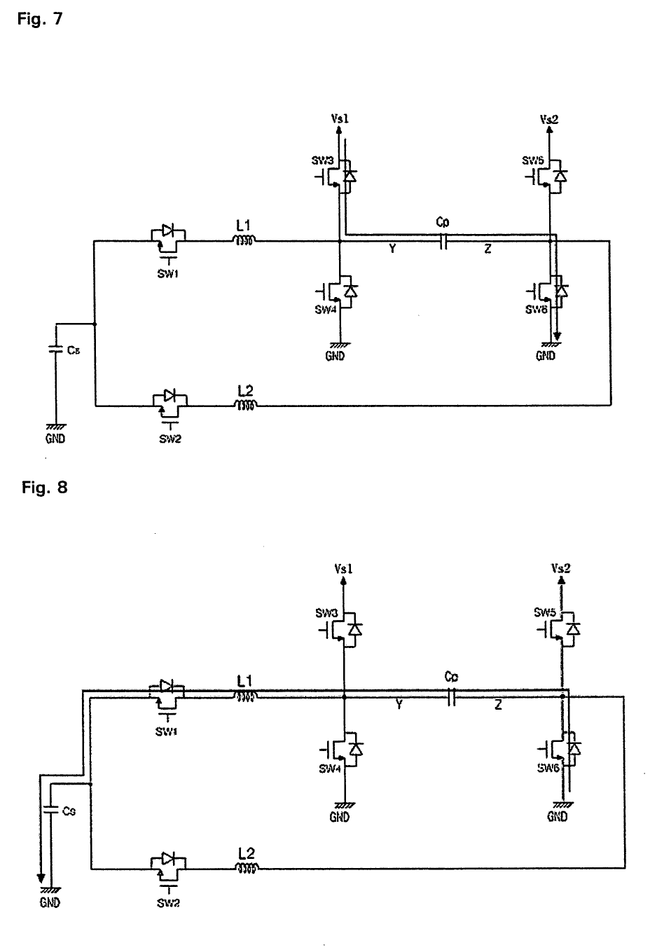

At the time point t3, the first switch is turned off in response to a first switching control signal of a low level which is supplied by the timing controller. The sixth switch SW6 remains in a turn-on state and the third switch SW3 is turned on in response to a sixth switching control signal of a high level and a thir switching control signal of a high level. As illustrated in FIG. 7, a current path comprising the third switch SW3, the scan electrode Y and the sixth switch SW6, is formed. The first voltage Vs1 is supplied to the scan electrode Y, and the second reference voltage is supplied to the sustain electrode Z.

At the time point t4, the third switch SW3 is turned off in response to a third switching control signal of a low level which is supplied by the timing controller. The sixth switch SW6 remains in a turn-on state and the first switch SW1 is turned on in response to a sixth switching control signal of a high level and a first swithing control signal of a high level which are supplied by the timing controller. As illustrated in FIG. 8, a current path comprising the sixth switch SW6, the sustain electrode Z, the scan electrode Y, the first inductor L1, the first switch SW1, and the capacitor Cs, is formed. Accordingly, the energy is recoved to the capacitor Cs. The capacitor Cs stores the energy corresponding to the half of the first voltage Vs1 because the first inductor L1 forms a serial resonance.

At the time point t5, the first switch SW1 is turned off in response to a first switching control signal of a low level supplied by the timing controller. The sixth switch SW6 remains in a turn-on state and the fourth switch SW4 is turned on in response to a sixth timing control signal of a high level and a fourth timing control signal of a high level which are supplied by the timing controller. As illustrated in FIG. 5, a current path comprising the fourth switch SW4, the scan electrode Y, the sustain electrode Z, and the sixth switch SW6, is formed. The first reference voltage and the second reference voltage are supplied to the scan electrode Y and the sustain electrode Z.

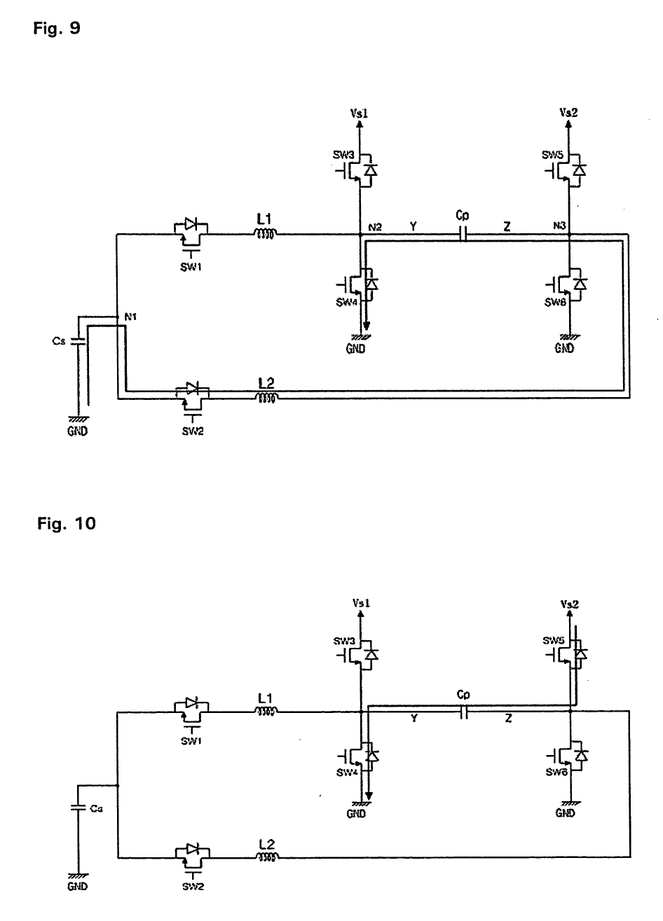

At the time point t6, the sixth switch SW6 is turned off in response to a sixth switching control signal of a low level supplied by the timing controller. The fourth switch SW4 remains in a turn-on state and the second switch SW2 is turned on in response to a fourth timing control signal of a high level and a second timing control signal of a high level which are supplied by the timing controller. As illustrated in FIG. 9, a current path comprising the capacitor Cs, the second inductor L2, the sustain electrode Z, the scan electrode Y, and the fourth switch SW4, is formed. The energy stored by the capacitor Cs is supplied to the sustain electrode Z. Because the second inductor L2 and the equivalent capacitor of the plasma display panel Cp form a serial resonance circuit, the energy corresponding to the half of the second voltage Vs2 is supplied to the sustain electrode Z.

At the time point t7, the second switch SW2 is turned off in response to a second switching control signal of a low level supplied by the timing controller. The fourth switch SW4 remains in a turn-on state and the fifth switch SW5 is turned on in response to a fourth timing control signal of a high level and a fifth timing control signal of a high level which are supplied by the timing controller. As illustrated in FIG. 10, a current path comprising the fifth switch SW5, the sustain electrode Z, the scan electrode Y and the fourth switch SW4, is formed. The second voltage Vs2 is supplied to the sustain electrode Z.

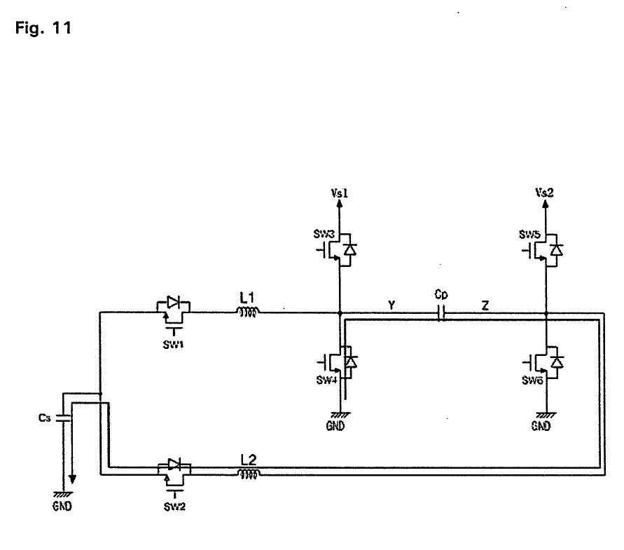

At the time point t8, the fifth switch SW5 is turned off in response to a fifth switching control signal of a low level supplied by the timing controller. The fourth switch SW4 remains in a turn-on state and the second switch SW2 is turned on in response to a fourth timing control signal of a high level and a second timing control signal of a high level which are supplied by the timing controller. As illustrated in FIG. 11, a current path comprising the fourth switch SW4, the scan electrode Y, the sustain electrode Z, the second inductor L2, the second switch SW2, and the capacitor Cs, is formed. The energy supplied to the plasma display panel Cp is recovered to the capacitor Cs. Because the second inductor L2 forms a serial resonance circuit, the energy corresponding to the half of the second voltage Vs2 is recovred.

The plasma display apparatus in accordance with the embodiment of the present invention supplies or recovers the energy through the first path comprising the first switch SW1 and the first inductor L1, and supplies or recovers the energy through the second path comprising the second switch SW2 and the second inductor L2. The energy is stored at one capacitor Cs. Accordingly, the plasma display apparatus in accordance with the embodiment of the present invention reduces a manufacturing cost. Because the energy is stored at one capacitor Cs and the path through which the energy is supplied is the same as the path through which the energy is recovered, The plasma display apparatus in accordance with the embodiment of the present invention prevents an energy recovery efficiency through the scan electrode Y from being different from the energy recovery efficiency through the sustain electrode Z.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a first electrode and a second electrode; and
a first path forming unit forming a first path for supplying an energy to the first electrode and for recoverying the energy from the first electrode;
a second path forming unit forming a second path for supplying the energy to the second electrode and for recoverying the enecgy from the second electrode; and
a capacitor storing the supplied or recovered energy.

2. The plasma display apparatus of claim 1, further comprising; a first voltage supply unit for supplying a first voltage or a first reference voltage, and a second voltage supply unit for supplying a second voltage or a second reference voltage.

3. The plasma display apparatus of claim 2, wherein
a magnitude of the first voltage is substantially equal to the magnitude of the second voltage.

4. The plasma display apparatus of claim 2, wherein
the first reference voltage and the second reference voltage are substantially equal to a ground level voltage.

5. The plasma display apparatus of claim 1, wherein
the first path forming unit comprises a first switch and a first inductor connected in serial each other, and the second path forming unit comprises a second switch and a second inductor connected in serial each other.

6. The plasma display apparatus of claim 5, wherein
the first switch is connected between the capacitor and the first inductor, and the second switch is connected between the capacitor and the second inductor.

7. A plasma display apparatus comprising:
a plasma display panel comprising a first electrode and a second electrode;
an energy supply/recovery unit supplying an energy to the first electorde or the second electrode and recovering the energy from the first electrode or the second electrode;
a first voltage supply unit remaining a voltage of the first electrode at a first voltage or a first reference voltage; and
a second voltage supply unit remaining a voltage of the second electrode at a second voltage or a second reference voltage.

8. The plasma display apparatus of claim 7, wherein
the energy recovery/supply unit comprises an energy storage unit for storing the energy,
a first switch and a first inductor connected between the energy storage unit and the first voltage supply unit to supply or recovery the energy to or from the first electrode, and
a second switch and a second inductor connected between the energy storage unit and the second voltage supply unit to supply or recovery the energy to or from the second electrode.

9. The plasma display apparatus of claim 8, wherein
the first switch is connected between the capacitor and the first inductor, and the second switch is connected between the capacitor and the second inductor.

10. The plasma display apparatus of claim 7, wherein
a magnitude of the first voltage is substantially equal to the magnitude of the second voltage.

11. The plasma display apparatus of claim 7, wherein
the reference voltage and the second reference voltage are substantially equal to a ground level voltage.

12. A driving method of a plasma display apparatus comprising a capacitor for storing an energy, a first electrode and a second electrode, comprising:
supplying an energy from the capacitor to the first electrode through a first path;
recovering the energy from the first electrode to the capacitor through the first path;
supplying the energy from the capacitor to the second electrode through a second path; and
recovering the energy from the second electrode to the capacitor through the second path.

13. The driving method of claim 12, wherein
a voltage of the first electrode remains at a first voltage after the supply of the energy to the first electrode, and a voltage of the second electrode remains at a second voltage after the supply of the energy to the second electrode.

14. The driving method of claim 13, wherein
a magnitude of the first voltage is substantially equal to the magnitude of the second voltage.

15. The driving method of claim 12, wherein
a voltage of the first electrode remains at a first reference voltage after the recovery of the energy from the first electrode, and a voltage of the second electrode remains at a second reference voltage after the recovery of the energy from the second electrode.

16. The driving method of claim 15, wherein
the reference voltage and the second reference voltage are substantially equal to a ground level voltage.
